(19) United States
(12) Patent Application Publication
(10) Pub. No.: US 2017/0030214 A1
(43) Pub. Date: Feb. 2, 2017

(54) Conformal Air Seal With Low Friction Maxmet Layer

(71) Applicant: United Technologies Corporation, Farmington, CT (US)

(72) Inventors: Christopher W Strock, Kennebunk, ME (US); Paul M Lutjen, Kennebunkport, ME (US); Shahram Amini, Glastonbury, CT (US); Sergei F Burlatsky, West Hartford, CT (US); Dmitri Novikov, Avon, CT (US)

(73) Assignee: United Technologies Corporation, Farmington, CT (US)

(21) Appl. No.: 15/113,566

(22) PCT Filed: Jan. 22, 2015
(86) PCT No.: PCT/US15/12349

§ 371 Date: Jul. 22, 2016

Related U.S. Application Data
(60) Provisional application No. 61/930,547, filed on Jan. 23, 2014.

(51) Int. Cl. F01D 11/08

(52) U.S. Cl. CPC F01D 11/08; F05D 2220/32; F05D 2230/236; F05D 2300/6032

(57) ABSTRACT

A turbine engine system comprising a turbine engine air seal having at least one contact portion. The turbine engine air seal having a MAXMET composite bonded to at least one contact portion.

### CROSS REFERENCE TO RELATED APPLICATION

This application claims the benefit of U.S. provisional application Ser. No. 61/930,547, filed Jan. 23, 2014.

### BACKGROUND

The present disclosure is directed to the use of MAXMET composite layers on the conformal seals of a turbine engine for sliding contact wear resistance.

Compressor technology uses air seal geometries to prevent unwanted air flow leakage. The seals utilize bare sheet metal components and in some cases certain conventional coatings are deployed over the metal. The surfaces of the seals are exposed to sliding contact wear or fretting wear due to relative motion with mating surfaces. The prior art seals that are bare sheet metal or even seals coated with wear resistant thermally sprayed coatings include high friction with mating surfaces. The higher relative friction increases the wear on the seals.

### SUMMARY

In accordance with the present disclosure, there is provided a turbine engine system comprising a turbine engine air seal having at least one contact portion, the turbine engine air seal having a MAXMET composite bonded to the at least one contact portion.

In another and alternative embodiment, the MAXMET composite is a composite having MAX phases and a metal matrix.

In another and alternative embodiment, the metal matrix is at least one of a low, medium, and high melting point metal or metal alloy.

In another and alternative embodiment, the MAX phases are defined by the formula Mₙ₊₁AXₙ where M is selected from the early transition metals, A is selected from A-group elements, X is selected from the group consisting of carbon and nitrogen, and n=1 to 3.

In another and alternative embodiment, the air seal is a W seal.

In another and alternative embodiment, the turbine engine air seal is a dog bone seal.

Further in accordance with the present disclosure, there is provided a turbine engine air seal comprising a body, the body having at least on contact portion, and a MAXMET composite bonded to the contact portion.

In another and alternative embodiment, the MAXMET composite is a composite having MAX phases and a metal matrix.

In another and alternative embodiment, the metal matrix is at least one of a low, medium, and high melting point metal or metal alloy.

In another and alternative embodiment, the MAX phases are defined by the formula Mₙ₊₁AXₙ where M is selected from the early transition metals, A is selected from A-group elements, X is selected from the group consisting of carbon and nitrogen, and n=1 to 3.

Further in accordance with the present disclosure, there is provided a process for manufacturing a turbine engine air seal, the process comprising the steps of providing a MAXMET composite material; providing a sheet metal having an air seal configuration to be used to form the turbine engine air seal; and joining the MAXMET composite to the sheet metal.

In another and alternative embodiment, the joining step comprises bonding of the MAXMET composite material to the sheet metal.

In another and alternative embodiment, the joining step comprises machining the sheet metal to form an air seal with a contact portion with the MAXMET composite material being joined to the contact portion

In another and alternative embodiment, the joining step comprises using one of plasma spray, high velocity oxy-fuel coating spraying, cold spray and laser powder cladding to join the MAXMET composite material to the substrate.

In another and alternative embodiment, the MAXMET composite providing step comprises providing a composite having MAX phases and a metal matrix.

In another and alternative embodiment, the metal matrix is a metal matrix and the MAX phases are defined by the formula Mₙ₊₁AXₙ where M is selected from the early transition metals, A is selected from A-group elements, X is selected from the group consisting of C and N, and n=1 to 3.

Other details of the MAXMET composite layers for turbine engine seals are set forth in the following detailed description and the accompanying drawing wherein like reference numerals depict like elements.

### BRIEF DESCRIPTION OF THE DRAWINGS

FIG. 1 is a schematic representation of a set of air seals for a gas turbine engine.

FIG. 1A is an expanded view of the air seals of FIG. 1.

FIG. 2 is a schematic representation of a MAXMET composite layer coating applied to a W-seal of a gas turbine engine.

FIG. 3 is a schematic representation of a MAXMET composite layer coating applied to a dog bone seal of a gas turbine engine.

### DETAILED DESCRIPTION

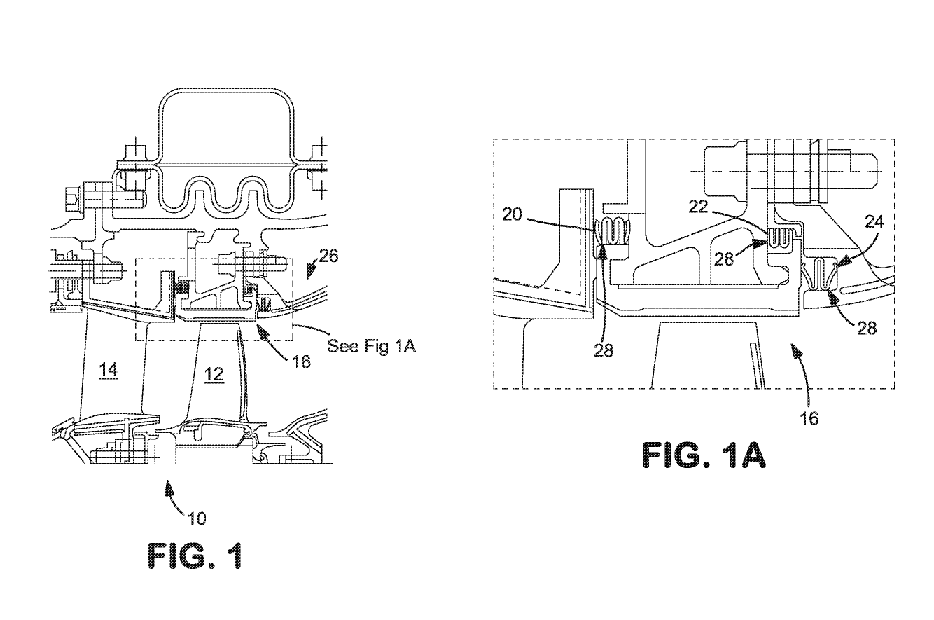

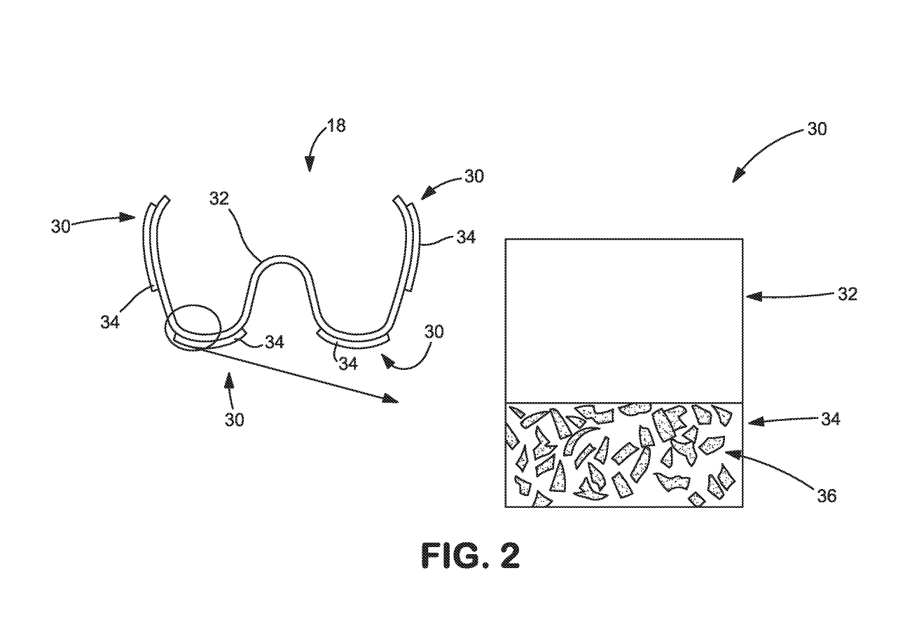

Referring now to FIG. 1, there is illustrated a cross sectional view of a portion of a gas turbine engine 10, with a blade 12 and vane 14 and associated blade air seal arrangement 16. In the exploded view of FIGS. 1A and 1n FIG. 2, the details of the blade air seal arrangement 16 include at least one air seal 18. The seals 18 are forward seal 20, mid seal 22 and rear seal 24. Surrounding the turbine engine air seal arrangement 16 is a casing 26. The air seals 18, 20, 22, 24 impinge on various surfaces and encounter sliding contact wear during relative motion with the mating parts 28 in the blade air seal arrangement 16. The location on the air seal 18 that contacts and wears is a contact portion 30.

The turbine engine air seals 18, 20, 22, 24 may be formed from a split hoop of sheet metal formed and folded into a bellows shaped structure or a body 32 having contact portions 30 at edges and along certain outer surfaces. The exemplary embodiment shown in the FIGS. 1, 1A and 2 are known as W seals, which are conformal seals that are bellows shaped and provide a spring compliance in one direction. The W seal is not compliant in the hoop direction, and therefore experiences a sliding contact wear when moved relative to the mating parts 28. In order to prevent or minimize the wear of the air seal 18 a low friction wear resistant layer is utilized.

On the contact portion 30 of the body 32, a composite material 34 is applied for protection against the wear resulting from the rub and abrasion from the sliding contact of the air seal 18 contact portion 20 against the mating parts 28. FIG. 2 includes a magnified view of the air seal 18 with the composite material 34 attached to the body 32. The composite material 34 is applied proximate the contact portions 30 of the body 32. In an exemplary embodiment, the composite material 34 is applied in an integral manner over the body 32.

The composite material 34 may be a MAXMET composite which is a MAX-based metal matrix composite 36. The composite can contain a MAX phase ternary carbide or nitride which are defined by the formula Mₙ₊₁AXₙ where n is a number from 1 to 3. M is an early transition metal element, A is an A group element, and X is carbon (C) or nitrogen (N) or both. Early transition metals are any element in the d-block of the periodic table, which includes groups 3 to 12 on the periodic table. A-group elements are mostly group IIA or IVA. The metal matrix is at least one of a low, medium, and high melting point metal or metal alloy. Low melting point metals or metal alloys are those approximately in the range of 100 degrees Centigrade to 300 degrees Centigrade. Medium melting point metals or metal alloys are those approximately in the range of 300 degrees Centigrade to 1000 degrees Centigrade. High melting point metals or metal alloys are those in the range of 1000 degrees Centigrade and greater. The MAX phases are layered hexagonal solids, in which near close-packed layers of early transition metals are interleaved with layers of pure A-group elements, or C and/or N atoms filling the octahedral sites between the transition metal layers. MAX Phases are machinable, damage tolerant, stiff and lightweight. The MAX Phases are nanolaminates, assemblages of microscopic layers analogous to many layered solids. MAXMET materials are characterized by excellent mechanical properties with improved toughness, high damage tolerance, high thermal stability, thermal conductivity, damping, high elastic stiffness, fatigue, thermal shock, creep resistance and improved erosion resistance. Some MAX Phases exhibit good bonding with metals, low friction coefficient and good fretting wear resistance. For a more detailed disclosure of MAX the following article is incorporated herein by reference, titled “Mechanical Properties of the MAX Phases,” found in the Encyclopedia of Materials Science and Technology, Eds, Buschow, Cahn, Flemings, Kramer, Mahajan and Veyssiere, published by Elsevier Science 2004.

The composite 34 may be applied to the contact portions 30 of the body 32 of the air seal 18 by spray or bonding of extruded, rolled, or powder metallurgy MMC layers.

While spraying and bonding have been described as techniques for joining the MAXMET composite 36 to the contact portion 30 of the air seal 18, other bonding techniques could be used. For example, one could use plasma spray, high-velocity oxy-fuel coating spraying, cold spray or laser powder cladding to apply the MAXMET composite 34 to the air seal 18.

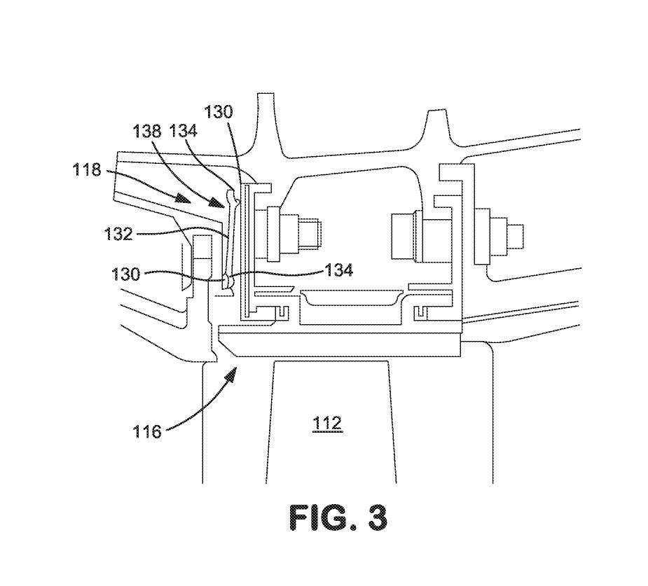

Referring to FIG. 3, an exemplary embodiment of an air seal 118 is shown as a dog bone seal 138. The dog bone seal 138 is shown as part of an air seal arrangement 116 proximate blade 112. The dog bone seal 138 includes a body 132 that includes contact portions 130. The contact portions 130 are proximate areas of mating parts 128 of the air seal arrangement 116 that come into contact with the air seal 118. The contact portion 130 of the dog bone air seal 138 can be coated with the composite material 134. The composite material 134 can comprise the MAXMET composite material described herein. The composite material 134 can be bonded or sprayed similar to the techniques described above and accounting for the different material properties of the body 132.

MAXMET composites have the potential to reduce frictional forces with low coefficient of friction. The MAXMET composites offer superb machinability with low energy of cut and self-lubricating capability. High thermal conductivity reduces local heat generation and creates cooler rub contact to prevent metal transfer to the abrasive coating. Strong bonding of MAX phases to metallic matrices increases toughness and provides processing capability with bulk and deposition techniques and ability to process with porosity. MAX phases will be durable in the oxidizing environment of a gas turbine's high pressure compressor up to 900 degrees Centigrade and more which exceeds the requirements for use in today's advanced gas turbines.

There has been provided a MAXMET composite for turbine engine air seals. While the MAXMET composite has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A turbine engine system comprising:
a turbine engine air seal having at least one contact portion;
said turbine engine air seal having a MAXMET composite bonded to at least one contact portion.

2. The turbine engine system according to claim 1, wherein said MAXMET composite is a composite having MAX phases and a metal matrix.

3. The turbine engine system according to claim 2, wherein said metal matrix is at least one of a low, medium, and high melting point metal or metal alloy.

4. The turbine engine system according to claim 2, wherein said MAX phases are defined by the formula Mₙ₊₁AXₙ where M is an early transition metal element, A is an A-group element, X is at least one of carbon and nitrogen, and n=1 to 3.

5. The turbine engine system according to claim 1, wherein said air seal is a W seal.

6. The turbine engine system according to claim 1, wherein said turbine engine air seal is a dog bone seal.

7. A turbine engine air seal comprising:
a body, said body having at least one contact portion; and
a MAXMET composite bonded to at least one contact portion.

8. The turbine engine air seal according to claim 7, wherein said MAXMET composite is a composite having MAX phases and a metal matrix.

9. The turbine engine air seal according to claim 8, wherein said metal matrix is at least one of a low, medium, and high melting point metal or metal alloy.

10. The turbine engine air seal according to claim 9, wherein said MAX phases are defined by the formula Mₙ₊₁AXₙ where M is an early transition metal element, A is an A group element, X is at least one of carbon and nitrogen, and n=1 to 3.

11. The turbine engine air seal according to claim 7, wherein said turbine engine air seal is a W seal.

12. The turbine engine system according to claim 7, wherein said turbine engine air seal is a dog bone seal.

13. A process for manufacturing a turbine engine air seal, said process comprising the steps of:
providing a MAXMET composite material;
providing a sheet metal having an air seal configuration to be used to form said turbine engine air seal; and
joining said MAXMET composite to said sheet metal.

14. The process of claim 13, wherein said joining step comprises diffusion bonding of said MAXMET composite material to said sheet metal.

15. The process of claim 13, wherein said joining step comprises thermal bonding of said MAXMET composite material to said sheet metal.

16. The process of claim 13, wherein said joining step comprises using one of plasma spray, high velocity oxy-fuel coating spraying, cold spray and laser powder cladding to join said MAXMET composite material to said sheet metal.

17. The process of claim 13, further comprising machining said sheet metal to form an air seal with a contact portion with said MAXMET composite material being joined to said contact portion.

18. The process of claim 13, wherein said MAXMET composite providing step comprises providing a composite having MAX phases and a metal matrix.

19. The process of claim 18, wherein said metal matrix is at least one of a low, medium, and high melting point metal or metal alloy and said MAX phases are defined by the formula Mₙ₊₁AXₙ where M is an early transition metal element, A is an A group element, X is at least one of carbon and nitrogen, and n=1 to 3.
